(19) United States
(12) Patent Application Publication
(10) Pub. No.: US 2020/0111337 A1
(43) Pub. Date: Apr. 9, 2020

(54) FEEL SAFE

(71) Applicant: AHMAD ABO ALSHEGHRI, Montreal (CA)

(72) Inventor: AHMAD ABO ALSHEGHRI, Montreal (CA)

(21) Appl. No.: 16/589,172

(22) Filed: Oct. 1, 2019

(30) Foreign Application Priority Data
Oct. 2, 2018 (CA) 3019569

(51) Int. Cl. G08B 13/196; H04N 7/18; G08B 25/01; G08B 25/08; H04W 4/90

(52) U.S. Cl. CPC G08B 13/19656; H04N 7/181; G08B 13/19695; G08B 13/19669; G08B 25/08; H04W 4/90; G08B 13/19684; G08B 25/016

(57) ABSTRACT

Feel safe is a Security system consists of platform and application connected to surveillance Centre 24 hours/7 days where customers can use this application in different ways to protect themselves.

Since the police doesn't interfere unless the crime happened, some people needs to feel safe if They expected trouble and the police can't offer them 24/7 surveillance service because they expect bad things to happen, and here we come to fill this gap.

Our service will be reason of reducing the crimes and saving people lives and helping the police department where our information will be available for them all the time.

Feel safe will create platform and mobile application for security purposes, this application will Be connected directly to our servers to record voice and video for anything happening when the customer open the application any time he needs it for security purposes, this application will Be connected to our servers in our control centre which opens 24 hours/7 days, our employees Will watch the incoming record and will interfere when there is a need.

Our main tools in this business are the platform, the application and the surveillance control Centre with the security employees and the accessories.

The application will allow us to know the location of the customer all the time so if anything happened to him we will notify the police about his location directly.

We will have advanced intelligent platform, will notify the security employees when the Customer possibly in trouble to check on him and call the police if needed.

We will get permission from the government to have access to their cameras in the public Places which will be extra tool to follow our customers if they are in dangerous situation.

The customer can contact us directly by the application to notify us if he is in trouble or expect to be in trouble and he can open his application to send us live video and since we know his location all the time we can send him the police instantly, The customer will have choice to Press one bottom on the application to notify us that he is in trouble and needs help or might Be in trouble or only by saying word help then the system will detect him.

We will provide our customers with unnoticed accessories like small hidden camera or Microphone which will be connected to the application wirelessly if their situation requires That.

We will provide the clients with cameras accessories connected to our application so they can watch what is happening at their home and work and also with special cameras for their kids to watch them any time they want especially if the kid is getting bullied

We will set the system to contact the police automatically in some cases.

We will have insurance policy for our business.

Who will need our services?
Elderly living alone to be watched all the time to inform the emergency if they have any Problem, especially the ones have mental problems, or severely sick, their families will not worry about them if they have our service.
Some body going to dangerous meeting he tell us before he goes and we provide him with Small unnoticed camera with microphone to perform surveillance while in the meeting to Interfere when needed.
taxi driver specially night time we will provide him with cameras connected to the application and when he suspect any passenger or the passenger start harassing him, he just press on the record bottom on the application and instantly this will be recorded in our system and showed On our screens where our employees will call the police if the situation needs, also he will have The proof for this incident.
If your kid is getting bullied you can provide him with our application and our hidden camera (Unnoticed shape) so when he get bullied he just hit the record bottom on our application then everything will be recorded on our system, where you can ask us for copy to give it to the school Or to the police, also the parents will have a feature in their application to see their kids and their location through our application any time they want.
Everybody using our application his location will be known to us to inform the police about his location when needed
Our apps can be connected wirelessly to cameras at home and work so the customer can see what is Going on all the time
If you are a women exposed to harassment, you can use our application and our hidden Camera (unnoticed shape) to get proof for the police.
People houses or businesses needed to be watched against theft, this will be instead of hiring security guard we will install surveillance system in their home or business connected to our centre to be watched and recorded 24/7 and call the police if needed where our service will be cheaper than having security guard.
if you are seriously sick and live alone you can use our 24/7 surveillance service to feel safe because you know that if you become in very bad situation and you can't call the emergency We will do it for you, we provide you with wireless bottom connected to our application when You press on it we will receive live video with flashing emergency light to interfere instantly.
if you are driving and you have conflict with another car or another driver is harassing you, you can use our service, we provide you with cameras connected wirelessly to our application you Install it in your car in four directions front, back, left, right and you have the option on the application to choose which one to activate for recording depends on the situation then we provide you with the video to give it to the police.
Any person lives under threat of being harassed, beaten, kidnapped or killed can use our Service to protect himself and his family.
Our services will be affordable for most of the people to increase the safety of themselves and their families.
Other customised services, where the client tell us what is his needs.
Our services prices for our application will be monthly flat rate and per minute for recording And per hour for surveillance, our prices will be cheaper than hiring security guard

The embodiments of the invention in which an exclusive property or privilege is claimed are defined as follows:

1. Feel safe will create plat form and mobile application for security purposes, this application will Be connected directly to our servers to record voice and video for anything happening when the customer open the application any time he needs it for security purposes, this application will Be connected to our servers in our control centre which open 24 hours/7 days, our employees Will be ready instantly to interfere when they see the incoming record.
Our main tools in this business are the plat form, the application and the surveillance control centre with the security employees and accessories.
Since the police don't interfere unless the crime happened, some people needs to feel safe if They expected trouble and the police can't offer them 24/7 surveillance service because they expect bad things to happen, and here we come to fill this gap.
Our service will be reason of reducing the crimes and saving people lives and helping the police department where our information will be available for them all the time.
The application will allow us to know the location of the customer all the time so if anything happened to him we will notify the police about his location instantly.
We will have advanced intelligent plat form, will notify the security employees when the Customer possibly in trouble to check on him and call the police if needed.
We will get permission from the government to have access to their cameras in the public places which will ease our job in following our customer if he is in dangerous situation.
The customer can contact us directly by the application to notify us if he is in trouble or expect to be in trouble and he can open his application to send us live video and since we know his location all the time we can send him the police instantly, The customer will have choice to Press one bottom on the application to notify us that he is in trouble and needs help or might Be in trouble or only by saying word help then the system will detect him.
We will provide our customers with unnoticed accessories like small hidden camera and Microphone which will be connected to the application wirelessly if their situation requires That.
We will set the system to contact the police automatically in some cases.
We will have insurance policy for our business.
Who will need our services?
Elderly living alone to be watched all the time to inform the emergency if they have any Problem, especially the ones have mental problems, or severely sick, their families will not worry about them if they have our service.
some body going to dangerous meeting he tell us before he goes and we provide him with Small unnoticed camera with microphone connected wirelessly to our application to perform surveillance while he is in the meeting to interfere when needed.
Taxi driver especially at night time we will provide him with cameras to install it in his car, it Will be connected to our application wirelessly and when he suspect any passenger or the passenger start harassing him, he just press on the record bottom on the application and Instantly this will be recorded in our system and showed on our screens where our employees Will call the police if the situation need, also he will have the proof for this incident.
If your kid is getting bullied you can provide him with our application and our hidden camera (Unnoticed shape) so when he get bullied he just hit the record bottom on our application then everything will be recorded on our system, where you can ask us for copy to give it to school or To the police.
If you are a women exposed to harassment, you can use our application and our hidden Camera (unnoticed shape) to get proof for the police.
People houses or businesses needed to be watched against theft, this will be instead of hiring security guard we will install surveillance system in their home or business connected with our Centre to be watched and recorded 24/7 and call the police if needed where our service will be cheaper than having security guard.
if you are seriously sick and live alone you can use our 24/7 surveillance service to feel safe because you know that if you become in very bad situation and you can't call the emergency We will do it for you, we provide you with wireless bottom connected to our application when You press on it we will receive live video with flashing emergency light to interfere instantly.
if you are driving and you have conflict with another car or another driver is harassing you, you can use our service, we provide you with cameras connected wirelessly to our application you install it in your car in four directions front, back, left, right and you have the option on the application to choose which one to activate for recording depend on the situation then we Provide you with the video to give it to the police.
any person lives under threat of being harassed, beaten, kidnapped or killed can use our service To protect himself and his family.
most of rich people need our service to increase the safety of themselves and their families.
other customised services, where the client tell us what is his needs.
Our services prices for our application will be monthly flat rate and per minute for recording And the surveillance will be per hour and this will depend on the effort required by us, our prices Will be cheaper than hiring security guard

2. Feel safe will create platform and mobile application for security purposes, this application will Be connected directly to our servers in our center to record voice and video for anything happening when the customer use the application any time he needs it for security purposes, this application will Be connected to our servers in our control centre which open 24 hours/7 days, our employees Will be ready instantly to interfere when they see the incoming record if needed.
Our main tools in this business are the platform, the application and the surveillance control centre with the security employees and accessories.
Since the police doesn't interfere unless the crime happened, some people needs to feel safe if They expected trouble and the police can't offer them 24/7 surveillance service because they expect bad things to happen, and here we come to fill this gap.
Our service will be reason of reducing the crimes and saving people lives and helping the police department where our information will be available for them all the time.
The application will allow us to know the location of the customer all the time so if anything happened to him we will notify the police about his location instantly.
We will have advanced intelligent platform, will notify the security employees when the Customer possibly in trouble to check on him and call the police if needed.
We will get permission from the government to have access to their cameras in the public places which will be extra tool to follow our customers if they are in dangerous situation.
The customer can contact us directly by the application to notify us if he is in trouble or expect to be in trouble and he can open his application to send us live video and since we know his location all the time we can send him the police instantly, The customer will have the choice to Press one bottom on the application to notify us that he is in trouble and needs help or might Be in trouble or only by saying word help then the system will detect him.
We will provide our customers with unnoticed accessories like small hidden camera and Microphone which will be connected to the application wirelessly if their situation requires That.
We will set the system to contact the police automatically in some cases.
We will have insurance policy for our business.
Who will need our services?
Elderly living alone to be watched all the time to inform the emergency if they have any Problem, especially the ones have mental problems, or severely sick, their families will not worry about them if they have our service.
some body going to dangerous meeting he tell us before he goes and we provide him with Small unnoticed camera with microphone connected wirelessly to our application to perform surveillance while he is in the meeting to interfere when needed.
Taxi driver especially at night time we will provide him with cameras to install it in his car, it Will be connected to our application wirelessly and when he suspect any passenger or the passenger start harassing him, he just press on the record bottom on the application and Instantly this will be recorded in our system and showed on our screens where our employees Will call the police if the situation needs, also he will have the proof for this incident.
If your kid is getting bullied you can provide him with our application and our hidden camera (Unnoticed shape) so when he get bullied he just hit the record bottom on our application then everything will be recorded on our system, where you can ask us for copy to give it to school or To the police, also the parents will have a feature in their application to see their kids and their location through our application any time they want.
If you are a women exposed to harassment, you can use our application and our hidden Camera (unnoticed shape) to get proof for the police.
People houses or businesses needed to be watched against theft, this will be instead of hiring security guard we will install surveillance system in their homes or businesses connected with our Centre where we will have movement sensors to detect any movement and send signal to our employees to interfere and call the police if needed, also we will have video record 24/7 to use it as proof for the crime, our service will be cheaper than paying security guard.
if you are seriously sick and live alone you can use our 24/7 surveillance service to feel safe because you know that if you become in very bad situation and you can't call the emergency We will do it for you, we provide you with wireless bottom connected to our application when You press on it we will receive live video with flashing emergency light to interfere instantly.
if you are driving and you have conflict with another car or another driver is harassing you, you can use our service, we provide you with cameras connected wirelessly to our application you install it in your car in four directions front, back, left, right and you have the option on the application to choose which one to activate for recording depend on the situation then we Provide you with the video to give it to the police.
any person lives under threat of being harassed, beaten, kidnapped or killed can use our service To protect himself and his family.
Our services will be affordable for most of the people to increase the safety of themselves and their families.
we will have customised services, where the client tells us what his needs are.
Our services prices for our application will be monthly flat rate and per minute for recording And per hour for surveillance, our prices will be cheaper than hiring security guard
